(19) United States
(12) Patent Application Publication
(10) Pub. No.: US 2015/0062889 A1
(43) Pub. Date: Mar. 5, 2015

(54) Straight Tube Type Lamp and Luminaire

(71) Applicant: TOSHIBA LIGHTING & TECHNOLOGY CORPORATION, YOKOSUKA-SHI (JP)

(72) Inventor: Manabu Kika, Yokosuka-shi (JP)

(73) Assignee: TOSHIBA LIGHTING & TECHNOLOGY CORPORATION, YOKOSUKA-SHI (JP)

(21) Appl. No.: 14/200,044

(22) Filed: Mar. 7, 2014

(30) Foreign Application Priority Data
Aug. 29, 2013 (JP) 2013-177973

(51) Int. Cl. F21V 23/06; F21S 4/00; F21K 99/00

(52) U.S. Cl. CPC F21V 23/06; F21K 9/17; F21S 4/008; F21Y 2103/003
USPC 362/223

(57) ABSTRACT

According to one embodiment, a straight tube type lamp includes a light source unit, a straight-tube cover and a cap. The cap includes an insulating cap body disposed at an end part of the straight-tube cover, a pair of terminals projecting from an end face of the cap body and an insulating projection. The projection includes a holding part arranged between the pair of terminals, and a projecting part which projects from a tip of the holding part in a direction of arrangement of the pair of terminals and is arranged at a tip side of the pair of terminals.

### INCORPORATION BY REFERENCE

The present invention claims priority under 35 U.S.C. §119 to Japanese Patent Application No. 2013-177973 filed on Aug. 29, 2013. The content of the application is incorporated herein by reference in their entirety.

### FIELD

Embodiments described herein relate generally to a straight tube type lamp and a luminaire using the straight tube type lamp.

### BACKGROUND

Hitherto, in some straight tube type lamps using light source units including LEDs, a cap including a pair of L-shaped terminals specified in the Japan Lighting Manufactures Association standard (JEL801) “Straight Tube Type LED Lamp System (for General Lighting) with L-shaped Pin Cap GX16t-5” is used instead of a G13 cap used in a straight tube type fluorescent lamp.

The pair of terminals is formed by bending flat metal plates into an L-shape, so that a function to prevent erroneous insertion into an incompatible socket for the G13 cap is obtained, and a function to prevent falling from a compatible socket is obtained.

Besides, there is a straight tube type fluorescent lamp having a T5 size (for example, 16 mm) whose tube diameter is smaller than that of the straight tube type fluorescent lamp using the G13 cap and using a G5 cap. In order to provide the straight tube type lamp using the light source unit including the LED correspondingly to this straight tube type fluorescent lamp, when the cap including the L-shaped terminals is used instead of the G5 cap, the terminals must be miniaturized in accordance with the miniaturization of the cap, and there is a fear that the strength of the terminals is insufficient.

When the strength of the terminals is insufficient, there is a fear that the terminals are deformed and an electrical defect occurs during the handling of the straight tube type lamp or during attachment to or detachment from the socket, or such a defect occurs that the erroneous insertion prevention and fall prevention functions are impaired.

### BRIEF DESCRIPTION OF THE DRAWINGS

FIG. 1 is a perspective view showing a straight tube type lamp of a first embodiment.

FIG. 2 is a perspective view showing a section of the straight tube type lamp.

FIG. 3 is a perspective view showing an inner structure of the straight tube type lamp.

FIG. 4 is a perspective view showing the whole straight tube type lamp.

FIG. 5 is a front view of a socket on which the straight tube type lamp is mounted.

FIG. 6 is a perspective view of a luminaire using the straight tube type lamp.

FIG. 7 is a wiring diagram of the luminaire.

FIG. 8 is a perspective view showing a straight tube type lamp of a second embodiment.

FIG. 9 is a perspective view showing a straight tube type lamp of a third embodiment.

### DETAILED DESCRIPTION

In general, according to one embodiment, a straight tube type lamp includes a light source unit, a straight-tube cover and a cap. At least a part of the straight-tube cover is translucent, and the straight-tube cover contains the light source unit. The cap includes an insulating cap body disposed at an end part of the straight-tube cover, a pair of terminals projecting from an end face of the cap body and an insulating projection. The projection includes a holding part arranged between the pair of terminals, and a projecting part which projects from a tip of the holding part in a direction of arrangement of the pair of terminals and is arranged at a tip side of the pair of terminals.

The erroneous insertion prevention and fall prevention functions are secured by the holding part and the projecting part of the projection projecting from the cap body, and the deformation of the terminal is expected to be prevented.

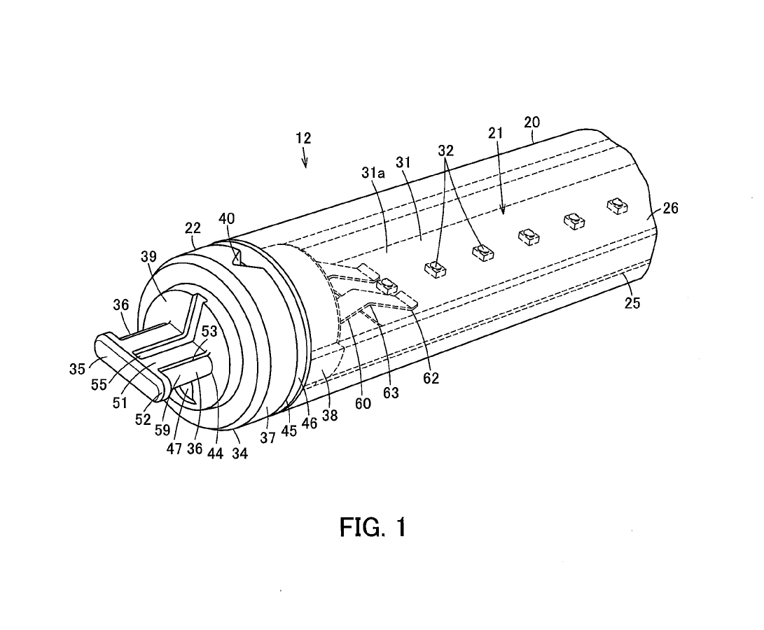

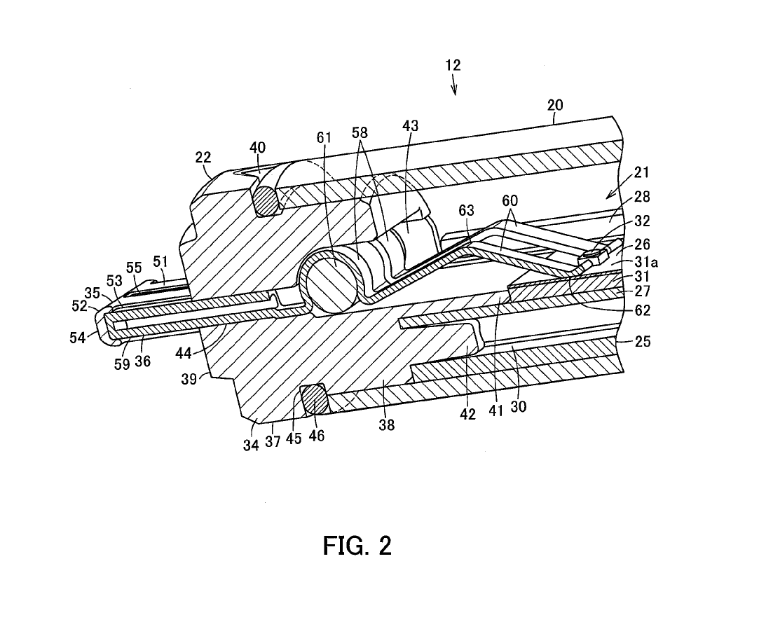

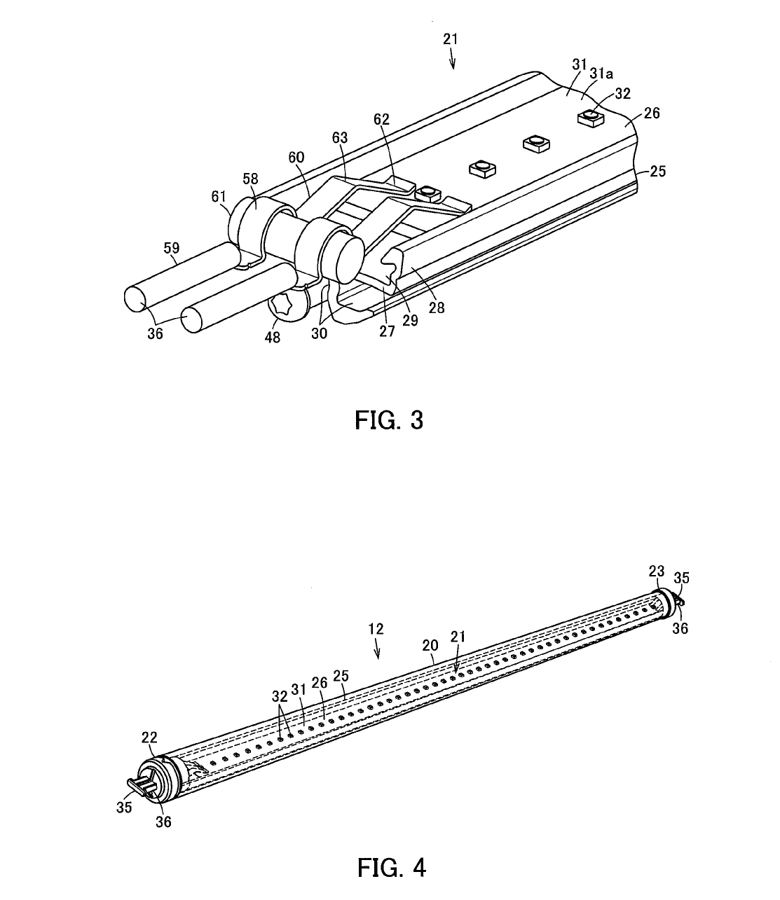

Hereinafter, a first embodiment will be described with reference to FIG. 1 to FIG. 7.

As shown in FIG. 6, a luminaire 10 includes a long luminaire body 11, a straight tube type lamp 12 arranged in the luminaire body 11, sockets 13 and 14 which are arranged at both ends of the luminaire body 11 so as to face each other and on which both ends of the straight tube type lamp 12 are mounted, and a power supply circuit 15 disposed in the luminaire body 11 and the like.

FIG. 1 to FIG. 4 show the straight tube type lamp 12. The straight tube type lamp 12 has, for example, a T5 size of 16 mm in tube diameter, and includes a cylindrical straight-tube cover 20, a light source unit 21 contained in the straight-tube cover 20, and caps 22 and 23 disposed at both ends of the straight-tube cover 20.

The straight-tube cover 20 is made of, for example, synthetic resin, and at least a part of a peripheral wall corresponding to a light irradiation direction is translucent.

The light source unit 21 includes a base 25 formed to be thin and long in a lamp longitudinal direction and a plurality of light-emitting modules 26 disposed on the base 25 along the lamp longitudinal direction.

The base 25 is a thermal radiator formed of a material such as aluminum by extrusion molding. The base 25 includes a flat base plate 27, and edge parts 28 are formed at a front side of the base plate 27 and at both side thereof in the width direction. The edge parts 28 are provided with groove parts 29 into which the light-emitting module 26 can be inserted from an end part in the lamp longitudinal direction and which hold the inserted light-emitting module 26. A plurality of groove parts 30 is formed at the back side of the base plate 27 along the lamp longitudinal direction.

The light-emitting module 26 includes a substrate 31 and a plurality of light-emitting elements 32 mounted on the substrate 31 along the lamp longitudinal direction. The substrate 31 is made of a material such as, for example, metal, ceramic or resin, and a wiring pattern surface 31a on which a wiring pattern is formed through an insulating layer is provided at the front side thereof. The light-emitting elements 32 are mounted on the wiring pattern surface 31a, and the light-emitting elements 32 are electrically connected to the wiring pattern. The light-emitting elements 32 are semiconductor light-emitting elements such as LED elements or EL elements. In the case of the LED elements, a surface mount type SMD (Surface Mount Device) package is used. Incidentally, a COB (Chip On Board) module in which a plurality of LED elements is mounted on the substrate 31 and is sealed with translucent resin containing phosphor may be used as the light-emitting module 26.

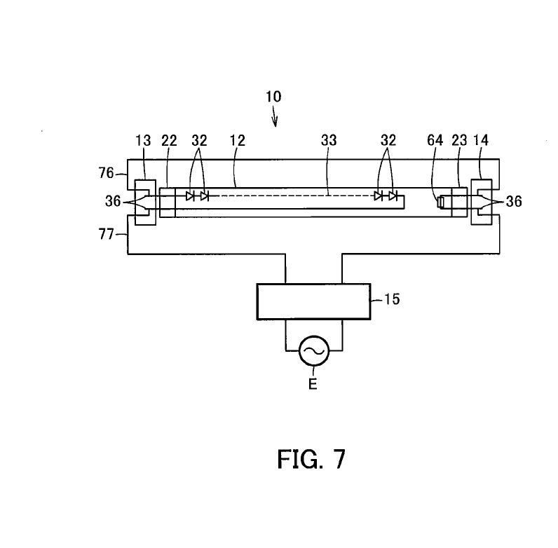

A series circuit 33 to which the plurality of light-emitting elements 32 is connected in series by the wiring pattern is formed on the substrate 31 (see FIG. 7), and a pair of power supply input parts of the series circuit 33 are provided at the cap 22 side of one end.

The caps 22 and 23 at both ends of the straight tube type lamp have the same structure. Each of the caps 22 and 23 includes a cap body 34, a substantially T-shaped projection 35 projecting from the outer end face of the cap body 34, and a pair of terminals 36 projecting from the outer end face of the cap body 34 at both sides of the projection 35.

The cap body 34 and the projection 35 are integrally molded of insulating synthetic resin. The pair of terminals 36 pass through from the inner end face of the cap body 34 to the outer end face and are combined.

The cap body 34 includes a cylindrical part 37 having a substantially same diameter as the straight-tube cover 20, a fitting part 38 projecting from the center area of the inner end face of the cylindrical part 37 and fitted to the inside of the straight-tube cover 20, and a base part 39 projecting from the center area of the outer end face of the cylindrical part 37.

The cylindrical part 37 is provided with a triangular recessed mark 40 which indicates the direction of the straight tube type lamp 12 corresponding to the light-emitting elements 32 and the direction of light irradiation direction of the straight tube type lamp 12.

A flat substrate press 41 which is inserted in the groove part 29 of the base 25 and regulates the end face position of the substrate 31 projects from the inner end face of the fitting part 38. Further, a plurality of insertion parts 42 projects therefrom, which is inserted in the plurality of groove parts 30 of the base 25 and is positioned by the base 25. A housing part 43 to house the terminals 36 is opened and formed in the inner end face of the fitting part 38 above the substrate press 41. A pair of insertion holes 44 through which the pair of terminals 36 is inserted is formed from the housing part 43 to the outer end face of the cap body 34.

A recess part 45 is formed on the peripheral surface of the fitting part 38 along the inner end face of the cylindrical part 37, and a ring 46 is fitted in the recess part 45. The ring 46 is made of silicone resin or rubber, for example, has elasticity and intervenes between the end face of the straight-tube cover 20 and the caps 22, 23 coupled to the base 25. The ring 46 absorbs the thermal expansion difference in the lamp longitudinal direction between the straight-tube cover 20 and the caps 22, 23 coupled to the base 25.

In the base part 39, the projection 35 integrally projects, the pair of terminals 36 is projected from the pair of insertion holes 44, and an attachment hole 47 is formed. The caps 22, 23 are fixed to the base 25 by screwing a screw 48 to the groove part 30 of the base 25 through the attachment hole 47.

The projection 35 includes a holding part 51 which projects from the outer end face of the cap body 34 and is arranged between the pair of terminals 36, and a projecting part 52 which projects in the direction of arrangement of the pair of terminals 36 from the tip of the holding part 51 and is arranged at the tip side of the pair of terminals 36. The projection is formed to be substantially T-shaped.

Semicircular holding grooves 53 in which the peripheral surface sides of the pair of terminals 36 facing each other are fitted are formed at both sides of the holding part 51. The projecting part 52 is provided with a pair of holding holes 54 in which the tips of the pair of terminals 36 are fitted.

In the projection 35, the projecting part 52 projects more than the pair of terminals 36 in the direction of arrangement of the pair of the terminals 36, and the holding part 51 and the projecting part 52 project more than the pair of terminals 36 in the direction perpendicular to the direction of arrangement of the pair of the terminals 36. Accordingly, the pair of terminals 36 is arranged inside the outer shape region of the holding part 51 and the projecting part 52.

Grooves 55 are formed on one surface and the other surface of the holding part 51 between the pair of terminals 36 from the cap body 34 to the projecting part 52. The groove 55 on the one surface of the holding part 51 is continuously formed to the outer end face of the cap body 34 (base part 39), and the groove 55 on the other surface of the holding part 51 is continuous with the attachment hole 47 formed in the outer end face of the cap body 34 (base part 39).

The pair of terminals 36 is formed by press-molding a conductive metal plate material, and respectively include fixing parts 58, cylindrical pins 59 projecting from one end of the fixing parts 58, and contact pieces 60 projecting from the other end of the fixing parts 58.

The fixing parts 58 are curved and formed. The fixing parts 58 of the pair of terminals 36 are fitted in an insulating cylindrical fixing member 61, and the pair of terminals 36 is integrally held in an insulating state from each other. The fixing parts 58 of the pair of terminals 36 and the fixing member 61 are housed in the housing part 43 of the cap body 34.

The pin 59 is formed into a cylindrical shape. The pin is inserted into the insertion hole 44 from the inner end face of the cap body 34, and projects from the outer end face of the cap body 34. The base end side of the pin 59 is inserted in the insertion hole 44 and is held. The tip side projecting from the cap body 34 is fitted in the holding groove 53 of the holding part 51 and the holding hole 54 of the projecting part 52 and is held.

A contact 62 which contacts the wiring pattern surface 31a of the substrate 31 and is electrically connected is formed at the tip of the contact piece 60. A bent part 63 bent in a direction of separating from the substrate 31 is formed at a middle part thereof. The contact piece 60 has elasticity in a direction in which the contact 62 is in press contact with the substrate 31.

The pair of terminals 36 of the cap 22 at one end is electrically connected to the pair of power supply input parts of the series circuit 33 formed on the substrate 31. The pair of terminals 36 at the other end is shorted through a fuse 64. The fuse 64 is mounted on, for example, the substrate 31. The pair of terminals 36 of the cap 23 at the other end contacts the wiring pattern surface 31a and is electrically connected, so that the pair of terminals is shorted through the fuse 64. Incidentally, the fuse 64 may be connected to the pair of terminals 36 without being mounted on the substrate 31.

Incidentally, the straight tube type lamp 12 is constructed such that the directions of arrangement of the pair of terminals 36 of the caps 22 and 23 at both ends are coincident with each other, and the direction of arrangement of the pair of terminals 36 is parallel to the wiring pattern surface 31a.

Besides, the thickness size of the holding part 51 and the projecting part 52 and the diameter size of the pair of terminals 36 are larger than the diameter size of the lamp pin specified for the G5 type cap. Thus, the caps 22 and 23 are not compatible with the G5 type cap, and can not be mounted (inserted) on the socket for the G5 type cap.

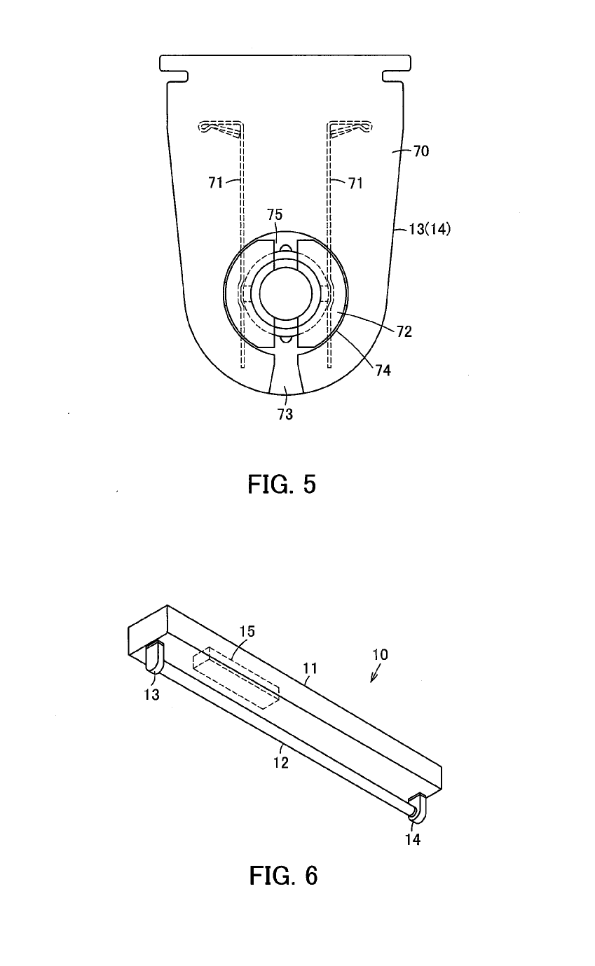

Besides, as shown in FIG. 5, a rotation mounting system is used for the sockets 13 and 14, in which after being inserted to a specified insertion position, the projection 35 and the pair of terminals 36 are rotated by 90° around the lamp axis of the straight tube type lamp 12 and are mounted. The sockets 13 and 14 have a common structure, and each of them includes a socket body 70, a pair of terminals 71 arranged in the socket body 70, and a rotator 72 rotatably arranged in the socket body 70. An insertion port 73 in which the projection 35 and the pair of terminals 36 are inserted is formed at the tip side of the socket body 70. A circular opening 74 in which the rotator 72 is rotatably arranged is formed in the front surface of the socket body 70. The pair of terminals 71 is arranged at both sides of the rotator 72. Insertion grooves 75 in which the projection 35 and the pair of terminals 36 are inserted are formed in the rotator 72.

FIG. 7 is a wiring diagram of the luminaire 10. The power supply circuit 15 receives power from a commercial AC power supply E and converts into specified DC power, and supplies the converted DC power to the light source unit 21 of the straight tube type lamp 12 through the sockets 13 and 14.

In the luminaire body 11, ones of the pair of terminals 71 of both the sockets 13 and 14 are electrically connected to each other through a connection line 76, and the others are electrically connected to a pair of feeders 77 of the power supply circuit 15. By this, even when the caps 22 and 23 of the straight tube type lamp 12 are connected to the sockets 13 and 14 in any direction, the power supply circuit 15 can supply power to the light source unit 21 of the straight tube type lamp 12.

When the straight tube type lamp 12 constructed as stated above is mounted between the sockets 13 and 14, after being inserted to the specified insertion position from the insertion ports 73 of the sockets 13 and 14 at the tip side, the projections 35 and the pair of terminals 36 of the caps 22 and 23 at both ends are rotated by 90° around the lamp axis of the straight tube type lamp 12 to the specified mount position.

When the straight tube type lamp 12 is rotated to the specified mount position, the pair of terminals 36 of the caps 22 and 23 contacts the pair of terminals 71 of the sockets 13 and 14 and is electrically connected.

In the mount state of the straight tube type lamp 12, the projecting part 52 projecting in the direction of arrangement of the pair of terminals 36 is caught on the sockets 13, 14 side (for example, the edge of the terminal 71), and even if size change in the lamp longitudinal direction occurs by temperature change of the straight tube type lamp 12 or deflection due to its own weight, the caps 22 and 23 of the straight tube type lamp 12 are prevented from falling off from the sockets 13 and 14.

Besides, the caps 22 and 23 including the projections 35 and the pair of terminals 36 are not compatible with the G5 type cap, can not be mounted (inserted) on the socket for the G5 type cap, but can be mounted (inserted) only on the suitable sockets 13 and 14.

Besides, the power supply circuit 15 converts AC power from the commercial AC power supply E into specified DC power, and supplies the converted DC power to the light source unit 21 of the straight tube type lamp 12 through the sockets 13 and 14. By this, the light-emitting elements 32 of the light source unit 21 are lit, and the light from the light-emitting elements 32 passes through the straight-tube cover 20 and is irradiated to lighting space.

In the caps 22 and 23 of the straight tube type lamp 12 of this embodiment, the insulating projection 35, together with the pair of terminals, projects from the end face of the cap body 34. The projection 35 includes the holding part 51 arranged between the pair of terminals 36, and the projecting part 52 which projects from the tip of the holding part 51 in the direction of arrangement of the pair of terminals 36 and is arranged at the tip side of the pair of terminals 36. By this structure, the rigidity of the pair of terminals 36 can be increased, and the erroneous insertion prevention and fall prevention functions can be secured not by the terminals 36 but by the holding part 51 and the projecting part 52. Accordingly, the terminals 36 can be prevented from being deformed by load application thereto.

Further, the projecting part 52 projects more than the pair of terminals 36 in the direction of arrangement of the pair of terminals 36, and the holding part 51 and the projecting part 52 project more than the pair of terminals 36 in the direction perpendicular to the direction of arrangement of the pair of terminals 36. Thus, the pair of terminals 36 can be arranged inside the outer shape region of the holding part 51 and the projecting part 52, and can be prevented from being deformed by load application thereto at the time of handling of the straight tube type lamp, at the time of attachment to and detachment from the sockets 13 and 14, or at the time of operation.

Besides, since the groove 55 is formed in the holding part 51 from the cap body 34 to the projecting part 52, even if the holding part 51 is arranged between the pair of terminals 36, a creeping distance between the pair of terminals 36 can be secured, and the insulation property can be improved.

Besides, the pair of terminals 36 passes through the cap body 34 and is connected to the wiring pattern surface 31a of the substrate 31. Accordingly, electrical connection can be obtained by assembling the caps 22 and 23 to the light source unit 21, and thus the assembling property is excellent, and the structure can be simplified.

Besides, the ring 46 intervening between the straight-tube cover 20 and the cap 22, 23 can absorb the expansion and contraction change of the straight-tube cover 20 in the lamp longitudinal direction due to temperature change.

Besides, since the cap body 34 and the projection 35 are integrally formed, the number of parts can be reduced and the assembling property can be improved.

Incidentally, the projection 35 may be formed separately from the cap body 34, and the projection 35 may be attached to the cap body 34.

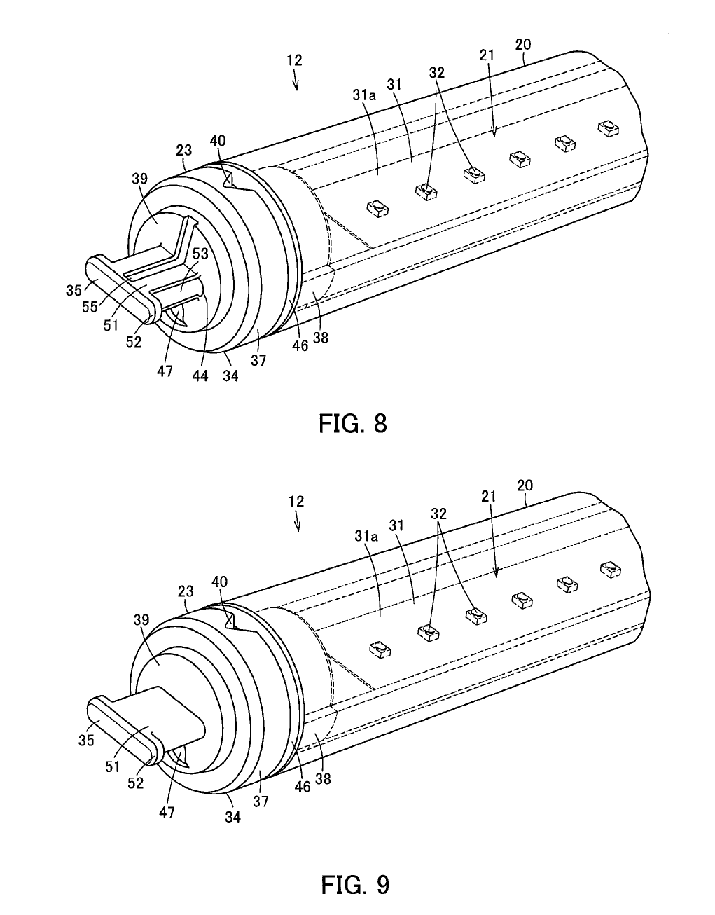

Next, a second embodiment is shown in FIG. 8. Incidentally, the same components as those of the first embodiment are denoted by the same reference numerals, and a description about the structure, operation and effect thereof is omitted.

In the straight tube type lamp 12, the cap 22 at one end is provided with the terminals 36 and is a power supply side, and the cap 23 at the other end is not provided with the terminals 36 and is a non-power supply side.

Although the cap 22 at the one end of the straight tube type lamp 12 has the same cap structure as that of the first embodiment, the cap 23 at the other end is such that the pair of terminals 36 is removed from the cap structure of the first embodiment. That is, the cap 23 at the other end includes only the cap body 34 in which the projection 35 is protrudingly provided.

In the straight tube type lamp 12 in which the cap 22 at the one end is the power supply side, and the cap 23 at the other end is the non-power supply side, the same cap body 34 as that of the cap 22 at the one end can be commonly used for the cap 23 at the other end, and the cost of parts can be reduced.

Next, a third embodiment is shown in FIG. 9. Incidentally, the same components as those of the first embodiment are denoted by the same reference numerals, and a description about the structure, operation and effect thereof is omitted.

The straight tube type lamp 12 is such that the cap 22 at one end is provided with the terminals 36 and is a power supply side, and the cap (second cap) 23 at the other end is not provided with the terminals 36 and is a non-power supply side.

Although the cap 22 at the one end of the straight tube type lamp 12 has the same cap structure as that of the first embodiment, the cap 23 at the other end includes the cap body (second cap body) 34 in which the protrusion (second protrusion) 35 including the holding part 51 and the projecting part 52 is protrudingly provided.

Both side surfaces of the holding part 51 in a width direction are formed to be arc-shaped. When the projection 35 is inserted into the socket 14, or is rotated and operated, the operation can be smoothly performed.

The insertion hole 44 is not opened in an end face of the cap body 34, and intrusion of insects and dust into the straight-tube cover 20 can be prevented.

In the case of the second and third embodiments, with respect to wiring between the straight tube type lamp 12 and the power supply circuit 15, the pair of feeders 77 of the power supply circuit 15 is connected only to the socket 13 at the one end, and power is supplied to the straight tube type lamp 12 from the cap 22 connected to the socket 13 at the one end.

Besides, in the case of the straight tube type lamp 12 in which the cap 22 at the one end is the power supply side and the cap 23 at the other end is the non-power supply side, colors of the rings 46 may be made different from each other, so that the cap 22 at the power supply side and the cap 23 at the non-power supply side are easily differentiated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A straight tube type lamp comprising:
a light source unit;
a straight-tube cover at least a part of which is translucent and which contains the light source unit; and
a cap including an insulating cap body disposed at an end part of the straight-tube cover, a pair of terminals projecting from an end face of the cap body, and an insulating projection, wherein the projection includes a holding part arranged between the pair of terminals, and a projecting part which projects from a tip of the holding part in a direction of arrangement of the pair of terminals and is arranged at a tip side of the pair of terminals.

2. The lamp according to claim 1, wherein the projecting part projects more than the pair of terminals in the direction of arrangement of the pair of terminals, and the holding part and the projecting part project more than the pair of terminals in a direction perpendicular to the direction of arrangement of the pair of terminals.

3. The lamp according to claim 1, wherein the pair of terminals is arranged inside an outer shape region of the holding part and the projecting part.

4. The lamp according to claim 1, wherein the holding part is provided with a groove from the cap body to the projecting part.

5. The lamp according to claim 1, wherein
the light source unit includes a substrate provided with a wiring pattern surface and a light-emitting element mounted on the wiring pattern surface of the substrate, and
the pair of terminals passes through the cap body and is connected to the wiring pattern surface of the substrate.

6. The lamp according to claim 1, wherein the cap body and the projection are integrally provided.

7. The lamp according to claim 1, wherein the caps having same structures are disposed at one end side and the other end side of the straight-tube cover.

8. The lamp according to claim 1, wherein the cap is disposed at one end side of the straight-tube cover, and only the cap body of the cap is disposed at the other end side of the straight-tube cover.

9. The lamp according to claim 1, wherein
the cap is disposed at one end side of the straight-tube cover, and a second cap is disposed at the other end side of the straight-tube cover, and
the second cap includes a second cap body disposed at the other end side of the straight-tube cover, and a second projection projecting from an end face of the second cap body.

10. The lamp according to claim 1, further comprising an elastic ring disposed between an end part of the straight-tube cover and the cap.

11. A luminaire comprising:
a straight tube type lamp including
a light source unit,
a straight-tube cover at least a part of which is translucent and which contains the light source unit, and
a cap including an insulating cap body disposed at an end part of the straight-tube cover, a pair of terminals projecting from an end face of the cap body and an insulating projection, wherein the projection includes a holding part arranged between the pair of terminals, and a projecting part which projects from a tip of the holding part in a direction of arrangement of the pair of terminals and is arranged at a tip side of the pair of terminals; and
a socket on which the straight tube type lamp is mounted.

12. The luminaire according to claim 11, wherein the projecting part projects more than the pair of terminals in the direction of arrangement of the pair of terminals, and the holding part and the projecting part project more than the pair of terminals in a direction perpendicular to the direction of arrangement of the pair of terminals.

13. The luminaire according to claim 11, wherein the pair of terminals is arranged inside an outer shape region of the holding part and the projecting part.

14. The luminaire according to claim 11, wherein the holding part is provided with a groove from the cap body to the projecting part.

15. The luminaire according to claim 11, wherein
the light source unit includes a substrate provided with a wiring pattern surface and a light-emitting element mounted on the wiring pattern surface of the substrate, and
the pair of terminals passes through the cap body and is connected to the wiring pattern surface of the substrate.

16. The luminaire according to claim 11, wherein the cap body and the projection are integrally provided.

17. The luminaire according to claim 11, wherein the caps having same structures are disposed at one end side and the other end side of the straight-tube cover.

18. The luminaire according to claim 11, wherein the cap is disposed at one end side of the straight-tube cover and only the cap body of the cap is disposed at the other end side of the straight-tube cover.

19. The luminaire according to claim 11, wherein
the cap is disposed at one end side of the straight-tube cover, and a second cap is disposed at the other end side of the straight-tube cover, and
the second cap includes a second cap body disposed at the other end side of the straight-tube cover, and a second projection projecting from an end face of the second cap body.

20. The luminaire according to claim 11, further comprising an elastic ring disposed between an end part of the straight-tube cover and the cap.
